(19) United States
(12) Patent Application Publication
(10) Pub. No.: US 2009/0328202 A1
(43) Pub. Date: Dec. 31, 2009

(54) MOBILE TERMINAL DEVICE, METHOD OF ACTIVATING TERMINAL APPARATUS FUNCTION AND COMPUTER READABLE MEDIUM

(75) Inventor: Yoshifumi HORINO, Yokohama (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/492,097

(22) Filed: Jun. 25, 2009

(30) Foreign Application Priority Data
Jun. 27, 2008 (JP) 2008-169613

(51) Int. Cl. G06F 21/20

(52) U.S. Cl. 726/19

(57) ABSTRACT

A method and apparatus for activation of a terminal apparatus function is disclosed. User identification information is received, and a characteristic of the user identification information is determined. The characteristic is compared to a required characteristic corresponding to the terminal apparatus function. A first activation process is selected if the characteristic matches the required characteristic; otherwise access to the terminal apparatus function is restricted.

### CROSS-REFERENCE TO RELATED APPLICATION

The present application claims priority under 35 U.S.C. §119 to Japanese Patent Application No. 2008-169613, filed on Jun. 27, 2008, entitled “MOBILE TERMINAL DEVICE, METHOD OF ACTIVATING A FUNCTION AND PROGRAM”. The content of which is incorporated by reference herein in its entirety.

### FIELD OF INVENTION

This invention relates generally to mobile terminals, and more particularly relates to multi-function mobile terminals.

### BACKGROUND OF THE INVENTION

In a terminal device having a telephone call function, a camera function, and an electronic mail function, sometimes a password is verified as an information leakage control measure in order to prevent a third party from using the functions when part or all of the functions of the terminal device are activated. A password input screen is shown on a display screen of the terminal device when a user activates a certain function, and the user follows instructions on the screen to enter the password. The terminal device verifies the entered password against a preset activating password. The function is activated when the entered password is matched with the preset activating password, and the function is not activated when the entered password does not match the preset activating password. Hereinafter, this password type of activating scheme is referred to as a “password scheme”.

In a terminal device used in companies such as a military company and a financial-related company in which highly confidential information is dealt with, the activation of part or all of the functions should be restricted. When a function whose activation is restricted is activated, the terminal device sends output to the display screen to notify the user that the function cannot be activated. Hereinafter, this function locking type of activating scheme is referred to as a “function lock scheme”.

A terminal device that is compatible with both the password scheme and the function lock scheme has been developed. When the terminal device receives an instruction to activate a certain function from the user, the terminal device sends to the display screen the password input screen or the screen notifying the user that the function activation cannot be activated according to the activating scheme associated with the function. However, a third party who obtains the terminal device is likely to easily discern that a particular function is confidential by looking at the display screen. This is because the activating schemes can easily be distinguished from each other and other types of content by examining the output contents of the display screen during the activation. Thus, there is a need for activating schemes that are not distinct from other screen contents.

### SUMMARY

A method and apparatus for activation of a terminal apparatus function is disclosed. User identification information is received, and a characteristic of the user identification information is determined. The characteristic is compared to a required characteristic corresponding to the terminal apparatus function. A first activation process is selected if the characteristic matches the required characteristic; otherwise access to the terminal apparatus function is restricted.

A first embodiment comprises a method for activating a terminal apparatus function. The method comprises receiving a user identification information, determining a characteristic of the user identification information, and comparing the characteristic to a required characteristic corresponding to the terminal apparatus function. The method further comprises selecting a first activation process and blocking a second activation process if the characteristic matches the required characteristic.

A second embodiment comprises a terminal apparatus. The terminal apparatus comprises an input unit operable to receive a user identification information. The terminal apparatus further comprises a control unit operable to determine a characteristic of the user identification information, compare the characteristic to a required characteristic corresponding to the terminal apparatus function, and select a first activation process and block a second activation process if the characteristic matches the required characteristic.

A third embodiment comprises a computer readable medium for activating a terminal apparatus function. The computer readable medium comprises program code for receiving a user identification information, and determining a characteristic of the user identification information. The computer readable medium further comprises program code for comparing the characteristic to a required characteristic corresponding to the terminal apparatus function, and selecting a first activation process and blocking a second activation process if the characteristic matches the required characteristic.

### BRIEF DESCRIPTION OF THE DRAWINGS

Embodiments of the present invention are hereinafter described in conjunction with the following figures, wherein like numerals denote like elements. The figures are provided for illustration and depict exemplary embodiments of the invention. The figures are provided to facilitate understanding of the invention without limiting the breadth, scope, scale, or applicability of the invention. The drawings are not necessarily made to scale.

FIG. 1 illustrates an example of the screen displayed in activating the function correlated with the function lock scheme.

FIG. 2 is a block diagram showing a configuration of a mobile terminal device according to one embodiment of the invention.

FIG. 3 illustrates an example of the data stored in the storage unit of the terminal device.

FIG. 4 is a flowchart illustrating an exemplary function activating operation in the terminal device according to one embodiment of the invention.

FIG. 5 illustrates an example of the password input screen.

FIG. 6 illustrates a configuration of a mobile device according to one embodiment of the invention.

FIG. 7 illustrates an example of the data stored in the storage unit in the terminal device according to one embodiment of the invention.

FIG. 8 is a flowchart illustrating an exemplary function activating operation in the terminal device according to one embodiment of the invention.

### DETAILED DESCRIPTION OF EXEMPLARY EMBODIMENTS

The following detailed description is exemplary in nature and is not intended to limit the invention or the application and uses of the embodiments of the invention. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the invention. Furthermore, there is no intention to be bound by any expressed or implied theory presented in the preceding technical field, background, brief summary or the following detailed description. The present invention should be accorded scope consistent with the claims, and not limited to the examples described and shown herein.

Embodiments of the invention are described herein in the context of practical non-limiting applications, namely, password scheme and the function lock scheme. Embodiments of the invention, however, are not limited to such password applications, and the techniques described herein may also be utilized in other authentication applications. For example embodiments may be applicable to biometric authentication application such as a face authentication, a fingerprint authentication, and a voice authentication that may be used as the activating methods. For example, for the activating method in which the fingerprint authentication scheme and the function lock scheme are included, when the user provides the instruction to activate the function, the terminal device may make a request for fingerprint authentication such that the user cannot distinguish between the fingerprint authentication scheme and the function lock scheme. Furthermore, although the mobile telephone is described as an example embodiment, the embodiments of the invention can also be applied, for example, but not limited to, a small-sized computer and a PDA.

As would be apparent to one of ordinary skill in the art after reading this description, these are merely examples and the embodiments of the invention are not limited to operating in accordance with these examples. Other embodiments may be utilized and structural changes may be made without departing from the scope of the exemplary embodiments of the present invention.

The following description is presented to enable a person of ordinary skill in the art to make and use the embodiments of the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the embodiments of the present invention. Thus, the embodiments of the present invention are not intended to be limited to the examples described herein and shown, but are to be accorded the scope consistent with the claims.

The terminal device according to an embodiment of the invention comprises a plurality of functions. As used herein, the function means, for example, but without limitation, an electronic mail function, a telephone call function, a camera function, a telephone call history viewing function, an electronic mail history viewing function, browser viewing function, and application function, which are possessed by the terminal device.

The terminal device is provided with, for example, but without limitation, an activating method that is compatible with the password scheme (first activating processing) and the function lock scheme (second activating processing). The functions may be correlated with one of the password scheme and the function lock scheme, or part of the plurality of functions may be correlated with one of the password scheme and the function lock scheme.

According to one embodiment of the invention, the function that is correlated with neither the password scheme nor the function lock scheme may immediately be activated upon input of the activation instruction. The case in which the function correlated with one of the password scheme and the function lock scheme is activated will be described below.

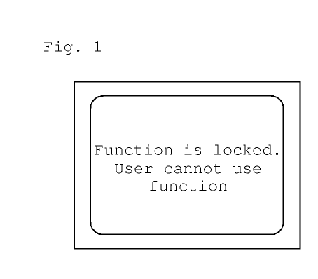

FIG. 1 illustrates an example of the screen displayed in activating the function correlated with the function lock scheme. The terminal device retains the activating password in each function correlated with one of the password scheme and the function lock scheme, and the terminal device controls the activation of each function based on the activating password. Specifically, the activation of the function is controlled based on the password scheme when the activating password of the function that the user provides the instruction to activate includes characters of a specific character type (for example, numeric character). On the other hand, the activation of the function is controlled based on the function lock scheme when the activating password of the function that the user provides the instruction to activate includes characters of a character type (general character type, for example, alphabetic character) that is different from the numeric character (specific character type).

The password input screen can be displayed on the display unit of the terminal device when the function activated by the user is the function correlated with one of the password scheme and the function lock scheme.

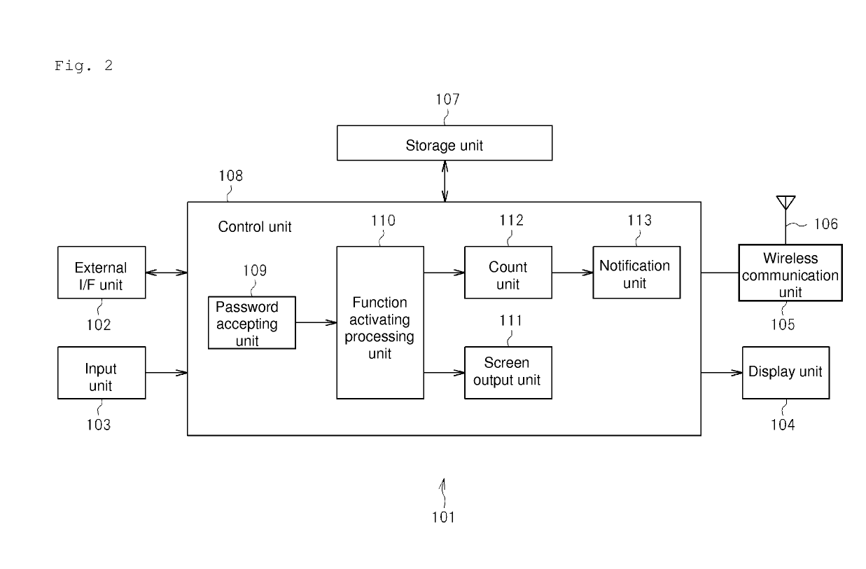

FIG. 2 is a block diagram showing a configuration of a mobile terminal device 101 (mobile telephone 101) as an example of a terminal device according to one embodiment of the invention. The mobile terminal device 101 may include, an exterior I/F unit 102, an input unit 103, a display unit 104, a wireless communication unit 105, an antenna 106, storage unit 107 (a memory) and a control unit 108. The control unit 108 comprises a password reception unit 109, a activation control unit 110, a screen output unit 111, a counting unit 112 and a notification unit 113.

The external I/F unit 102 is an interface used to connect the mobile telephone 101 to an external device such as a USB terminal.

An input unit 103 is an input device such as numeric keypad. The input unit 103 detects the key pressed by the user to output a signal indicating the pressed key to a control unit 108.

The display unit 104 may comprise an image display device such as, without limitation, a light emitting diode (LED) display, a liquid crystal display (LCD), or an organic EL display (OLED). The display unit 104 may be used to display the password input screen based on a signal input from a screen output unit 111.

The wireless communication unit 105 is configured to communicate with a wireless communication system (not shown) via an access point such as a base station. The wireless communication unit 105 communicates with the base station, and transmits and/or receives various kinds of data such as voice data during a voice call, mail data during transmitting/receiving mail, and web page data during webpage browsing. The wireless communication unit 105 may comprises a communication signal processing circuit including a semiconductor circuit. The wireless communication unit 105 receives data that the mobile telephone 101 transmits from the control unit 108, and then converts the data into a transmitting signal to output the transmitting signal to an antenna 106. The wireless communication unit 105 also converts a signal received by the antenna 106 into data to output the data to the control unit 108.

The antenna 106 transmits the transmitting signal input from the wireless communication unit 105 as a radio signal, and then receives the radio signal transmitted from an external device to output the received radio signal to the wireless communication unit 105.

A storage unit 107 is a storage device, such as a semiconductor circuit and a hard disk drive. The storage unit 107 is operable to store various kinds of data used for various processes of the mobile telephone 101. In practical embodiments, the storage unit 107 may comprise, for example, a non-volatile memory or storage device (non-volatile semiconductor memory, hard disk device, optical disk device, and the like), a random access storage device (for example, SRAM, DRAM), or any other form of storage medium known in the art. For example, the storage unit 107 may store a computer program which is executed by the control unit 108, an address book for managing personal information such as telephone numbers and e-mail addresses, an audio file for reproducing a ring tone and alarm tone, an image file for a standby screen, various kinds of setting data, a temporary data used in a program process, number of authentication failures C, and the like. The storage unit 107 may be coupled to the control unit 108 such that the control unit 108 can read information from and write information to storage unit 107. As an example, the control unit 108 and storage unit 107 may reside in their respective ASICs in which the activating password of each function is stored. The activating password is written in the storage unit 107 from a host computer connected to the external I/F unit 102 through the external I/F unit 102 and the control unit 108 or from the input unit 103 through the control unit 108. The storage unit 107 may also be integrated into the control unit 108. In an embodiment, the storage unit 107 may include a cache memory for storing temporary variables or other intermediate information during execution of instructions to be executed by the control unit 108. The storage unit 108 may use the non-volatile memory for storing instructions to be executed by the control unit 108.

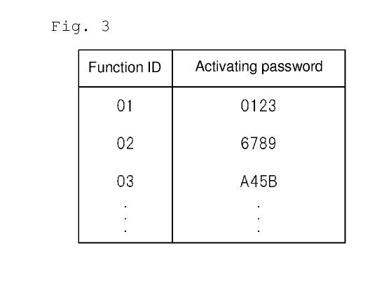

FIG. 3 illustrates an example of the data stored in the storage unit 107 of the mobile telephone 101. The activating password of the function correlated with the password scheme includes the numeric character (character of specific character type) such as _number “5”, and the activating password of the function correlated with the function lock scheme includes at least one alphabetic character (character of general character type) such as letter “C”. A function designated by a function ID “01” and a function designated by a function ID “02” are correlated with the password scheme, a function designated by a function ID “03” is correlated with the function lock scheme.

The control unit 108 includes a semiconductor circuit comprising a CPU, and controls the operation of the mobile telephone 101. Using the signals input from the external I/F unit 102 and input unit 103, the control unit 108 performs an operation to produce signals for controlling the operations of the display unit 104 and storage unit 107, and to output the signals to the display unit 104 and the storage unit 107.

When the instruction to activate the function is input, a password accepting unit 109 accepts the password including the numeric characters in the passwords input from the input unit 103, and then outputs the accepted password to a function activating processing unit 110. For example, when the characters are input from the input unit 103 while input modes (a mode in which the numeric character is input and a mode in which the alphabetic character is input, hereinafter the modes are referred to as numeric character mode and alphabetic character mode, respectively) are switched, the password accepting unit 109 controls the input mode to fix the input mode to the numeric character mode in inputting the password. Alternatively, when the password including at least one alphabetic character is input, the accepting operation is interrupted, and processing is performed to display “alphabetic character cannot be input” on the display unit 104.

For example, as shown in FIG. 3, the activating passwords (required characteristic) of the functions designated by the function ID “01” and function ID “02” include the numeric characters, and the activating password of the function designated by the function ID “03” includes the alphabetic characters. Therefore, the password accepting unit 109 accepts the activating passwords of the functions designated by the function ID “01” and function ID “02”, while the password accepting unit 109 does not accept the activating password of the function designated by the function ID “03”.

When the password is input from the password accepting unit 109, the function activating processing unit 110 reads the activating password of the function designated by the activation instruction input through the input unit 103 from the storage unit 107. The function activating processing unit 110 verifies the read password against the password output from the password accepting unit 109, and then activates the function if the read password is matched with the password output from the password accepting unit 109.

In FIG. 3, the result of the password verification becomes “match” when the correct password is input from the input unit 103 in activating the functions designated by the function ID “01” and function ID “02”, and the result of the password verification does not become “match” because the password accepting unit 109 does not accept the correct password in activating the function designated by the function ID “03”.

A screen output unit 111 produces and outputs an image displayed on the display unit 104. The screen output unit 111 produces the password input screen to output the password input screen to the display unit 104, when the activation instruction is input into the function activating processing unit 110 through the input unit 103 while the function designated by the activation instruction is correlated with one of the password scheme and the function lock scheme.

A count unit 112 counts the number of mismatch times in the result of the password verification that is performed by the function activating processing unit 110 in activating each function. The count unit 112 may count the number of mismatch times for each function, or may count the number of mismatch times in common with some functions. The count unit 112 may reset the count value after a predetermined time elapses since the result of the password verification finally becomes the mismatch.

A notification unit 113 refers to the count value of the count unit 112, and then performs notification processing to other devices except for the mobile telephone 101 through the wireless communication unit 105 and antenna 106 when the count value reaches a predetermined value. For example, the notification unit 113 produces and transmits a warning mail to a preset address. At this point, the current position of the mobile telephone may be described in a main body of the electronic mail using a GPS function of the mobile telephone. A warning message may be transmitted to a preset telephone number.

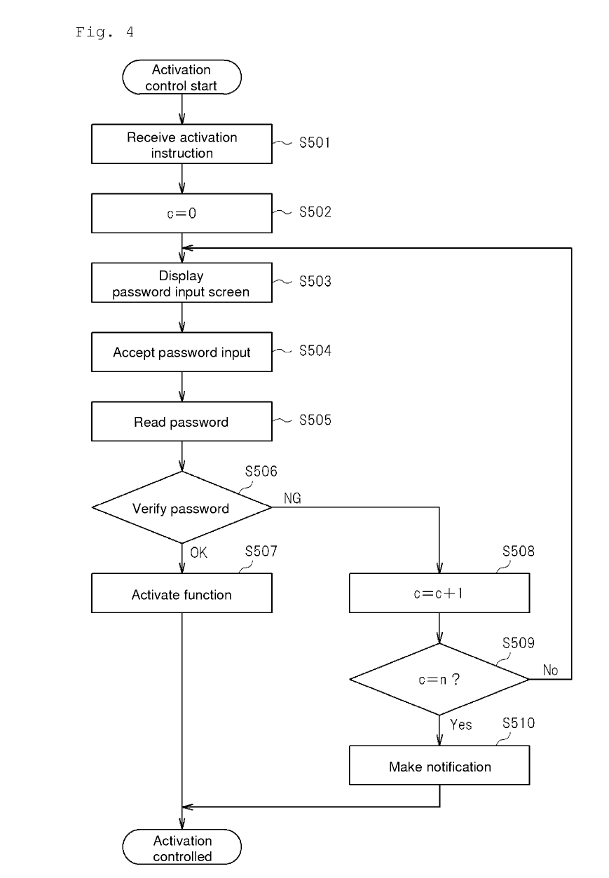

FIG. 4 is a flowchart illustrating an exemplary process 400 for function activating operation in the terminal device according to an embodiment of the invention. The various tasks performed in connection with process 400 may be performed by software, hardware, firmware, or any combination thereof. For illustrative purposes, the following description of process 400 may refer to elements mentioned above in connection with FIGS. 1-3. In practical embodiments, portions of process 400 may be performed by different elements of the described system, e.g., the communication unit 105, the, the screen output unit 111, the storage unit 107, the function activating processing unit 110, the count unit 112, and the notification unit 113. Process 400 may include any number of additional or alternative tasks. The tasks shown in FIG. 4 need not be performed in the illustrated order, and process 400 may be incorporated into a more comprehensive procedures or processes comprising additional functionality not described in detail herein.

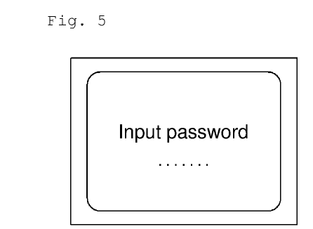

Process 400 may being by the mobile telephone 101 starting the activation control, and then receiving the instruction to activate a certain function through the input unit 103 (task S501). The count unit 112 resets the count value c to zero (task S502). FIG. 5 illustrates an example of the password input screen. The screen output unit 111 produces the password input screen as illustrated in FIG. 5 to output the password input screen to the display unit 104, and then displays the password input screen based on the input from the screen output unit 111 (task S503).

When the user follows the instructions of the password input screen to input the password (characteristic) through the input unit 103, the password accepting unit 109 accepts the password including the numeric character (character of specific character type), and then outputs the accepted password to the function activating processing unit 110 (task S504).

When receiving the password from the password accepting unit 109, the function activating processing unit 110 reads the activating password of the function designated by the activation instruction from the storage unit 107 (task S505). The function activating processing unit 110 verifies the read activating password against the password output from the password accepting unit 109 (task S506), then activates the function when the read activating password is matched with the password output from the password accepting unit 109 (task S507), and thus the activation control is ended.

When the result of the verification in task S506 becomes “mismatch”, the count unit 112 adds one to the count value c (task S508), and the notification unit 113 determines whether the count value c reaches a predetermined value n (task S509). The mobile telephone 101 returns to the state in task S503 when the count value c does not reach the predetermined value n. When the count value c reaches the predetermined value n, the mobile telephone 101 makes a notification that the count value c reaches the predetermined value n using the notification unit 113, the wireless communication unit 105, and the antenna 106 (S510). Then the activation control is ended.

In the configuration of the mobile telephone 101, when the function correlated with one of the password scheme and the function lock scheme is activated, because the password input screen is shown on the display unit 104, a determination whether the function to be activated is correlated with the password scheme or the function lock scheme is hardly made from the screen display.

Further, according to one embodiment, the function corresponding to the password including the character of the general character type is not activated because the password accepting unit 109 does not accept the password including the character of the general character type. Therefore, a certain function can be correlated with the function lock scheme by setting the password including the character of the general character type to some function. At this point, because the activating password of each function becomes activating scheme identification information, flag information for identifying the activating scheme is not required.

For example, when the third party (i.e., unauthorized user) repeatedly inputs a wrong password in order to activate the function, the authorized user or manager can sense the use of the third party by receiving the notification.

The terminal device retains flag information indicating which function the function is compatible with in each function correlated with one of the password scheme and the function lock scheme, and the activation of each function is controlled based on the flag information.

The password input screen is shown on the display unit of the terminal device when the function activated by the user is the function correlated with one of the password scheme and the function lock scheme.

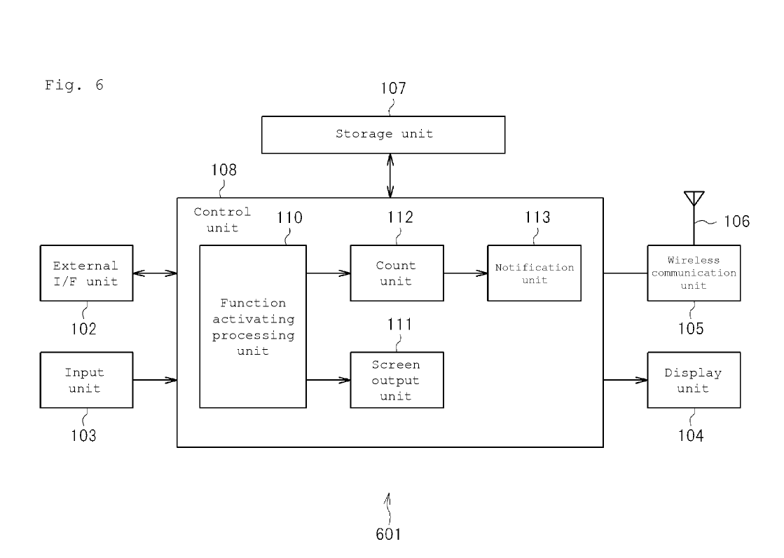

FIG. 6 illustrates a configuration of a mobile telephone 601. The configuration of the mobile telephone 601 differs from that of the mobile telephone 101 shown in FIG. 2 in that output of the input unit 103 is directly input into the function activating processing unit 110. The embodiment shown in FIG. 6 may share similar features and functionalities to the mobile telephone 101. Common features, functions, and elements will not be redundantly described here. Therefore, the storage unit 107, the function activating processing unit 110, and the count unit 112, of which the operations and contents are different from those of the mobile telephone 101, will be described below.

The storage unit 107 is a storage device, which is same as or similar to the storage unit 107 in FIG. 2, such as a semiconductor memory and a hard disk drive. The flag information indicating the activating scheme of each function and the activating password of the function correlated with the password scheme are stored in the storage unit 107. The control unit 108 reads and writes the data from and in the storage unit 107. The flag information and the activating password are written in the storage unit 107 from a computer connected to the external I/F unit 102 through the external I/F unit 102 and the control unit 108 or from the input unit 103 through the control unit 108.

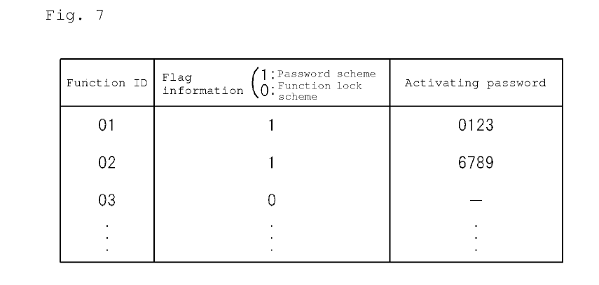

FIG. 7 illustrates an example of the data stored in the storage unit 107 in the mobile telephone 601. The flag information indicates which of the password scheme or the function lock scheme the function is correlated with. The activating password is also stored for the function correlated with the password scheme.

When receiving the activation instruction from the user through the input unit 103, the function activating processing unit 110 reads the flag information on the function designated by the activation instruction from the storage unit 107.

When receiving the password through the input unit 103 while the function is correlated with the password scheme, the function activating processing unit 110 reads the activating password of the function from the storage unit 107, and then verifies the password received through the input unit 103 against the password read from the storage unit 107. The function activating processing unit 110 activates the function when the password received through the input unit 103 is matched with the password read from the storage unit 107.

When receiving the password through the input unit 103 while the function is correlated with the function lock scheme, the function activating processing unit 110 outputs a count instruction signal to the count unit 112. The count unit 112 is a counter that counts the number of times in which the password is input into the mobile telephone 601 in activating the function correlated with the function lock scheme. The count unit 112 adds one to the count value when receiving the count instruction signal from the function activating processing unit 110. The count unit 112 may count the number of mismatch times for each function, or may count the number of mismatch times in common with some functions. The count unit 112 may reset the count value after a predetermined time elapses since the result of the password verification finally becomes the mismatch.

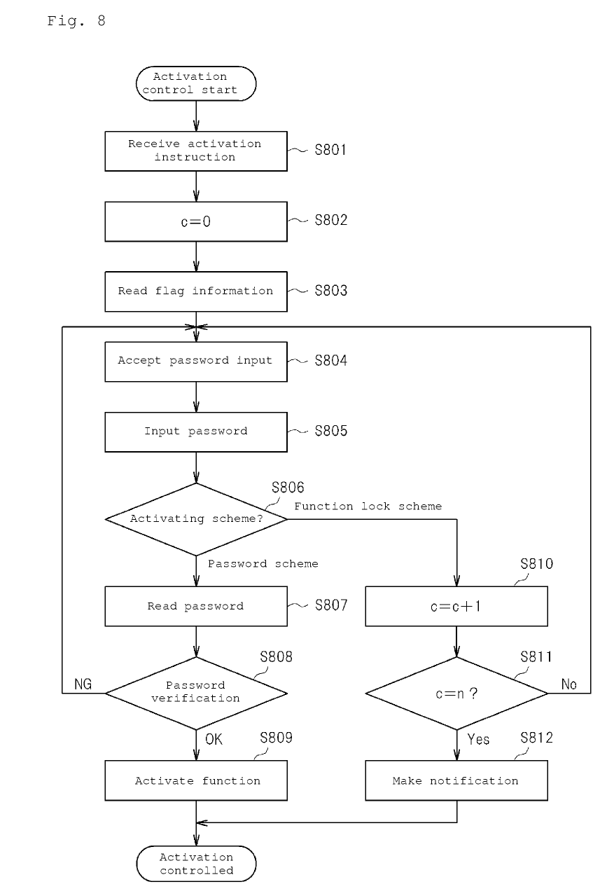

FIG. 8 is a flowchart illustrating an exemplary process 800 for function activating operation in the terminal device 601 (mobile telephone 601) according to an embodiment the invention. The various tasks performed in connection with process 800 may be performed by software, hardware, firmware, or any combination thereof. For illustrative purposes, the following description of process 400 may refer to elements mentioned above in connection with FIGS. 1 and 3-7. In practical embodiments, portions of process 800 may be performed by different elements of the described system, e.g., the input unit 103, the communication unit 105, the screen output unit 111, the storage unit 107, the function activating processing unit 110, the count unit 112, and the notification unit 113, etc. Process 800 may include any number of additional or alternative tasks. The tasks shown in FIG. 8 need not be performed in the illustrated order, and process 800 may be incorporated into a more comprehensive procedure or process comprising additional functionality not described in detail herein.

Process 800 may begin by the mobile telephone 601 activating control, and then receiving an instruction to activate a certain function through the input unit 103 (task S801). The count unit 112 reset the count value c to zero (task S802). The function activating processing unit 110 reads the flag information of the function designated by the activation instruction from the storage unit 107 to recognize the activating scheme (task S803). The screen output unit 111 produces the password input screen as illustrated in FIG. 5 to output the password input screen to the display unit 104. The display unit 104 displays the password input screen based on the input from the screen output unit 111 (task S804).

When the user follows the instructions of the password input screen to input the password through the input unit 103 (task S805), the function activating processing unit 110 refers to the activating scheme recognized in task S803 (task S806).

When the activating scheme is the password scheme, the function activating processing unit 110 reads the activating password of the function designated by the activation instruction from the storage unit 107 (task S807), and then verifies the read activating password against the password input through the input unit 103 (task S808). When the read activating password is matched with the password input through the input unit 103, the function activating processing unit 110 activates the function (task S809), and the activation control is ended. The mobile telephone 601 returns to the state in task S804 when the read activating password is not matched with the password input through the input unit 103. The mobile telephone 601 may return to the state in task S810 instead of the state in task S804 when the read activating password is not matched with the password input through the input unit 103.

When the activating scheme is the function lock scheme in task S806, the function activating processing unit 110 provides the count instruction to the count unit 112. The count unit 112 adds one to the count value c (task S810), and the notification unit 113 determines whether the count value c reaches the predetermined value n (task S811). The mobile telephone 601 returns to the state in task S804 when the count value c does not reach the predetermined value n. When the count value c reaches the predetermined value n, the mobile telephone 601 makes the notification that the count value c reaches the predetermined value n using the notification unit 113, the wireless communication unit 105, and the antenna 106 (task S812). Then the activation control is ended.

The control unit 108 causes the function activating processing unit 110 to perform the activation (first activating processing) of the function correlated with the password scheme or the activation (second activating processing) of the function correlated with the function lock scheme based on the identification information that is stored in the storage unit 107 while correlated with the function designated by the user's activation instruction. Therefore, when the function correlated with one of the password scheme and the function lock scheme is activated, because the password input screen is shown on the display unit 104, the determination of the activating scheme cannot be made from the screen display.

For example, when the third party repeatedly inputs a password in order to activate the function correlated with the function lock scheme, the authorized user or manager can sense the use of the third party by receiving the notification.

In the embodiments, the numeric character is set to the specific character type and the alphabetic character is set to the general character type. Alternatively other character groups that are not overlapped with each other may be used. For example, a special sign may be set to the specific character type and the numeric character may be set to the general character type.

While at least one exemplary embodiment has been presented in the foregoing detailed description, the present invention is not limited to the above-described embodiment or embodiments. Variations may be apparent to those skilled in the art. In carrying out the present invention, various modifications, combinations, sub-combinations and alterations may occur in regard to the elements of the above-described embodiment insofar as they are within the technical scope of the present invention or the equivalents thereof. The exemplary embodiment or exemplary embodiments are examples, and are not intended to limit the scope, applicability, or configuration of the invention in any way. Rather, the foregoing detailed description will provide those skilled in the art with a template for implementing the exemplary embodiment or exemplary embodiments. It should be understood that various changes can be made in the function and arrangement of elements without departing from the scope of the invention as set forth in the appended claims and the legal equivalents thereof. Furthermore, although embodiments of the present invention have been described with reference to the accompanying drawings, it is to be noted that changes and modifications may be apparent to those skilled in the art. Such changes and modifications are to be understood as being included within the scope of the present invention as defined by the claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

What is claimed is:

1. A method for activating a terminal apparatus function, the method comprising:
receiving a user identification information;
determining a characteristic of the user identification information;
comparing the characteristic to a required characteristic corresponding to the terminal apparatus function; and
selecting a first activation process and blocking a second activation process if the characteristic matches the required characteristic.

2. The method of claim 1, further comprising activating the first activation process if the characteristic matches the required characteristic.

3. The method of claim 1, further comprising activating the second activation process if the characteristic does not matches the required characteristic.

4. The method of claim 1, further comprising activating the second activation process if the characteristic does not match the required characteristic and does match a second characteristic.

5. The method of claim 1, further comprising displaying a password input screen based on a user activation instruction.

6. The method of claim 4, wherein the second activation process comprises a restricting access to a function requested by the user activation instruction.

7. The method of claim 6, further comprising:
verifying the user identification information to obtain a password verification; and
allowing access to the terminal apparatus function based on the password verification.

8. The method of claim 1, wherein the user identification information comprises a password.

9. The method of claim 8, wherein the characteristic comprises a specific character type of the user password and the required characteristic comprises a specific character type of an activating password.

10. A terminal apparatus, comprising:
an input unit operable to receive a user identification information;
a control unit operable to:
determine a characteristic of the user identification information;
compare the characteristic to a required characteristic corresponding to a terminal apparatus function; and
select a first activation process and block a second activation process if the characteristic matches the required characteristic.

11. The terminal apparatus of claim 10, further comprising:
a count unit operable to provide a count of an occurrence of the characteristic not matching the required characteristic; and
a notification unit operable to notify one or more devices when the count has reached a predetermined number.

12. The terminal apparatus of claim 10, further comprising a function activation processing unit operable to activate the first activation process if the characteristic matches the required characteristic.

13. The terminal apparatus of claim 12, further comprising a display controller operable to display a password input screen on a display unit based on the user activation instruction.

14. The terminal apparatus of claim 13, wherein:
the input unit is further operable to receive user identification information, and
the function activation processing unit is further operable to:
verify the user identification information to obtain a password verification; and
allow access to the terminal apparatus function based on the password verification.

15. The terminal apparatus of claim 10, wherein:
the user identification information comprises a user password,
the characteristic comprises a specific character type of the user password; and
the required characteristic comprises a specific character type of an activating password.

16. A computer readable medium for activating a terminal apparatus function comprising program code for:
receiving a user identification information;
determining a characteristic of the user identification information;
comparing the characteristic to a required characteristic corresponding to the terminal apparatus function; and
selecting a first activation process and blocking a second activation process if the characteristic matches the required characteristic.

17. The computer readable medium of claim 16, further comprising program code for activating the first activation process if the characteristic matches the required characteristic.

18. The computer readable medium of claim 16, wherein:
the user identification information comprises a user password;
the characteristic comprises a specific character type of the user password; and
the required characteristic comprises a specific character type of an activating password.

19. The computer readable medium of claim 16, further comprising program code for activating the second activation process if the characteristic does not match the required characteristic and does match a second characteristic.

20. The computer readable medium of claim 16, wherein the second activation process comprises a restricting access to a function requested by a user activation instruction.
